(19) United States
(12) Patent Application Publication
(10) Pub. No.: US 2026/0321026 A1
(43) Pub. Date: Oct. 15, 2026

(54) RECOGNITION DEVICE, RECOGNITION METHOD, VEHICLE CONTROL DEVICE, AND STORAGE MEDIUM

(71) Applicant: HONDA MOTOR CO., LTD., Tokyo (JP)

(72) Inventors: Kaisei Honda, Tokyo (JP); Yoshiki Ono, Tokyo (JP)

(21) Appl. No.: 19/543,893

(22) Filed: Feb. 19, 2026

(30) Foreign Application Priority Data
Mar. 28, 2025 (JP) 2025-056456

(51) Int. Cl. G06V 20/56; B60W 50/00; B60W 50/14; B60W 60/00; G06V 10/764; G06V 10/776; G06V 20/58

(52) U.S. Cl. CPC G06V 20/588; G06V 10/764; G06V 10/776; G06V 20/582; B60W 2050/0022; B60W 50/0097; B60W 50/14; B60W 60/001; B60W 2420/403; B60W 2552/53; B60W 2555/60; B60W 2720/10

(57) ABSTRACT

A recognition device includes a classification unit configured to calculate a predicted score of each of a plurality of recognition target classes and an invalid class using an image of a recognition target area detected by a detection unit and to classify a recognition target as one of the plurality of recognition target classes and the invalid class on the basis of the calculated predicted scores. The classification unit includes a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value.

### CROSS-REFERENCE TO RELATED APPLICATION

Priority is claimed on Japanese Patent Application No. 2025-056456, filed Mar. 28, 2025, the content of which is incorporated herein by reference.

### BACKGROUND OF THE INVENTION

### Field of the Invention

The present invention relates to a recognition device, a recognition method, a vehicle control device, and a storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on automated driving technology. In this regard, a technique of increasing reliability when a sign or marking of a road or a road surface recognized from an image matches a sign or marking stored in a storage unit in recognition of surroundings of a mobile object and determining that the road sign stored in the storage unit is a road sign corresponding to a current position when the reliability is equal to or greater than a predetermined value is known in the related art (for example, see Patent Document 1).
[Patent Document 1] Japanese Unexamined Patent Application, First Publication No. 2019-212188

### SUMMARY OF THE INVENTION

In order to allow a vehicle to travel smoothly using a function such as an automated driving (AD) function or an advanced driver assistance systems (ADAS) function, it is necessary to accurately and fully recognize information which can be obtained from a traffic environment. For example, a road marking often has information complementary to a road sign, but it is essential for a road sign to be recognized in view of prevention of a decrease in reliability of a recognizer as a whole due to occlusion or a decrease in recognition accuracy.

On the other hand, the technology using a reliability value described in Patent Document 1, a segmentation technique which is a road sign recognition technique, a sorting learning technique, a template matching technique, and the like are known. However, no technique is based on the premise that data indicating true road markings is used as training data and the markings are detected and recognized. In the related art, the number of labels is limited, and thus there is a problem in that a sign not included in training data is erroneously recognized when it is to be recognized.

Aspects of the present invention were invented in consideration of the aforementioned circumstances, and an objective thereof is to provide a recognition device, a recognition method, a vehicle control device, and a storage medium that can reduce erroneous recognition of an object not to be recognized and improve recognition accuracy.

In order to achieve the aforementioned objective, the present invention employs the following aspects.
(1) According to an aspect of the present invention, there is provided a recognition device including: an imaging unit configured to capture a surroundings image of a traveling lane in which a host vehicle is traveling; a detection unit configured to detect a recognition target area including a recognition target from the surrounding image captured by the imaging unit; and a classification unit configured to calculate a predicted score of each of a plurality of recognition target classes and an invalid class using an image of the recognition target area detected by the detection unit and to classify the recognition target as one of the plurality of recognition target classes and the invalid class on the basis of the calculated predicted scores, wherein the classification unit includes a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value.
(2) In the aspect of (1), the recognition target may be a road marking, the detection unit may detect a road marking area from the surrounding image, and the classification unit may calculate the predicted score of each of a plurality of road marking classes and an invalid class using an image of the road marking area detected by the detection unit and classify the road marking as one of the plurality of road marking classes and the invalid class on the basis of the calculated predicted scores.
(3) In the aspect of (1) or (2), the classification unit may include a second classification processing unit configured to calculate a predicted score of a first invalid class using the recognition target in the first recognition target class classified by the first classification processing unit and to classify the recognition target as the invalid class when the predicted score of the first invalid class is greater than a second threshold value.
(4) In the aspect of (1) or (2), the classification unit may include a second classification processing unit configured to calculate the predicted score of the invalid class using the recognition target classified as an arrow class which is the first recognition target class by the first classification processing unit, to classify the recognition target as the invalid class when the predicted score of the invalid class is greater than a third threshold value, to calculate a predicted score of each of a plurality of detailed arrow classes including a shape and a direction of an arrow when the predicted score of the invalid class is less than the third threshold value, and to classify the recognition target as the detailed arrow class with the highest predicted score out of the plurality of detailed arrow classes.
(5) In the aspect of (1) or (2), the classification unit may include a second classification processing unit configured to calculate the predicted score of the invalid class using the recognition target classified as a character string class which is the first recognition target class by the first classification processing unit, to classify the recognition target as the invalid class when the predicted score of the invalid class is greater than a fourth threshold value, to calculate a predicted score of each of a plurality of detailed character string classes including a meaning of a character string when the predicted score of the invalid class is less than the fourth threshold value, and to classify the recognition target as the detailed character string class with the highest predicted score out of the plurality of detailed character string classes.
(6) In the aspect of (1) or (2), the classification unit may include a second classification processing unit configured to calculate the predicted score of the invalid class using the recognition target classified as a speed class which is the first recognition target class by the first classification processing unit, to classify the recognition target as the invalid class when the predicted score of the invalid class is greater than a fifth threshold value, to calculate a predicted score of each of a plurality of detailed speed classes including a numerical value of a speed when the predicted score of the invalid class is less than the fifth threshold value, and to classify the recognition target as the detailed speed class with the highest predicted score out of the plurality of detailed speed classes.
(7) In the aspect of (1) or (2), the first classification processing unit may calculate a first loss value (a cross entropy) for the predicted score of the first recognition target class and a second loss value (a binomial entropy) for the predicted score of the invalid class, and the first classification processing unit may perform classification using a machine learning model learning a value obtained by adding a value obtained by multiplying the cross entropy by a first weight and a value obtained by multiplying the binomial entropy by a second weight as a loss function.
(8) In the aspect of (1) or (2), the first threshold value may be changed to a smaller value as a classification accuracy becomes lower due to a surrounding environmental factor of the host vehicle.
(9) In the aspect of (1) or (2), the classification unit may perform classification of the recognition target at intervals of a predetermined period and output a classification result on the basis of a result of comparison between a classification result of a previous period and a classification result of a current period.
(10) According to another aspect of the present invention, there is provided a vehicle control device including: a recognition device including an imaging unit configured to capture a surrounding image of a traveling lane in which a host vehicle is traveling, a detection unit configured to detect a recognition target area including a recognition target from the surrounding image captured by the imaging unit, and a classification unit configured to calculate a predicted score of each of a plurality of recognition target classes and an invalid class using an image of the recognition target area detected by the detection unit and to classify the recognition target as one of the plurality of recognition target classes and the invalid class on the basis of the calculated predicted scores, wherein the classification unit includes a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value and a second classification processing unit configured to calculate the predicted score of the invalid class using the recognition target classified as an arrow class which is the first recognition target class by the first classification processing unit, to classify the recognition target as the invalid class when the predicted score of the invalid class is greater than a third threshold value, to calculate a predicted score of each of a plurality of detailed arrow classes including a shape and a direction of an arrow when the predicted score of the invalid class is less than the third threshold value, and to classify the recognition target as the detailed arrow class with the highest predicted score out of the plurality of detailed arrow classes; a vehicle control unit configured to control a vehicle on the basis of the recognition target recognized by the recognition device; and a traveling lane recognizing unit configured to recognize the traveling lane of the host vehicle on the basis of position information of the host vehicle, wherein the vehicle control unit compares the shape and the direction of the detailed arrow class recognized by the recognition device with the traveling lane recognized by the traveling lane recognizing unit and verifies a recognition accuracy of the recognition device on the basis of a result of comparison.
(11) According to another aspect of the present invention, there is provided a vehicle control device including: a recognition device including an imaging unit configured to capture a surrounding image of a traveling lane in which a host vehicle is traveling, a detection unit configured to detect a recognition target area including a recognition target from the surrounding image captured by the imaging unit, and a classification unit configured to calculate a predicted score of each of a plurality of recognition target class and an invalid class using an image of the recognition target area detected by the detection unit and to classify the recognition target as one of the plurality of recognition target classes and the invalid class on the basis of the calculated predicted scores, wherein the classification unit includes a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value and a second classification processing unit configured to calculate the predicted score of the invalid class using the recognition target classified as a character string class which is the first recognition target class by the first classification processing unit, to classify the recognition target as the invalid class when the predicted score of the invalid class is greater than a fourth threshold value, to calculate a predicted score of each of a plurality of detailed character string classes including a meaning of a character string when the predicted score of the invalid class is less than the fourth threshold value, and to classify the recognition target as the detailed character string class with the highest predicted score out of the plurality of detailed character string classes; and a vehicle control unit configured to control a vehicle on the basis of the recognition target recognized by the recognition device, wherein the vehicle control unit notifies an occupant of the host vehicle or controls a speed of the host vehicle when characters of the detailed character string class recognized by the recognition device are characters associated with a crossing.
(12) According to another aspect of the present invention, there is provided a vehicle control device including: a recognition device including an imaging unit configured to capture a surrounding image of a traveling lane in which a host vehicle is traveling, a detection unit configured to detect a road marking area including a road marking from the surrounding image captured by the imaging unit, a classification unit configured to calculate a predicted score of each of a plurality of road marking class and an invalid class using an image of the road marking area detected by the detection unit and to classify the road marking as one of the plurality of road marking classes and the invalid class on the basis of the calculated predicted scores, wherein the classification unit includes a first classification processing unit configured to classify the road marking as the invalid class when the predicted score of the invalid class is greater than a predetermined first threshold value and to classify the road marking as a first road marking class with the highest predicted score out of the plurality of road marking classes when the predicted score of the invalid class is less than the first threshold value and a second classification processing unit configured to calculate the predicted score of the invalid class using the road marking classified as a speed class which is the first road marking class by the first classification processing unit, to classify the road marking as the invalid class when the predicted score of the invalid class is greater than a fifth threshold value, to calculate a predicted score of each of a plurality of detailed speed classes including a numerical value of a speed when the predicted score of the invalid class is less than the fifth threshold value, and to classify the road marking as the detailed speed class with the highest predicted score out of the plurality of detailed speed classes, and a speed marking recognizing unit configured to recognize a speed marking from the surrounding image captured by the imaging unit; and a vehicle control unit configured to control a vehicle on the basis of the road marking recognized by the recognition device, wherein the vehicle control unit compares a speed of the detailed speed class recognized by the recognition device with a speed of the speed marking recognized by the speed marking recognizing unit and notifies an occupant of the host vehicle or controls a speed of the host vehicle on the basis of a result of comparison.
(13) According to another aspect of the present invention, there is provided a recognition method that is performed by a computer, the recognition method including: detecting a recognition target area including a recognition target from a surrounding image captured by an imaging unit configured to capture a surrounding image of a traveling lane in which a host vehicle is traveling; calculating a predicted score of each of a plurality of recognition target classes and an invalid class using an image of the detected recognition target area; classifying the recognition target as one of the plurality of recognition target classes and the invalid class on the basis of the calculated predicted scores; classifying the recognition target as the invalid class when the predicted score of the invalid class is greater than a predetermined first threshold value; and classifying the recognition target as a first recognition target class with the highest predicted score out of the plurality of recognition target classes when the predicted score of the invalid class is less than the first threshold value.
(14) According to another aspect of the present invention, there is provided a non-transitory computer-readable storage medium storing a program, the program causing a computer to perform: detecting a recognition target area including a recognition target from a surrounding image captured by an imaging unit configured to capture a surrounding image of a traveling lane in which a host vehicle is traveling; calculating a predicted score of each of a plurality of recognition target classes and an invalid class using an image of the detected recognition target area; classifying the recognition target as one of the plurality of recognition target classes and the invalid class on the basis of the calculated predicted scores; classifying the recognition target as the invalid class when the predicted score of the invalid class is greater than a predetermined first threshold value; and classifying the recognition target as a first recognition target class with the highest predicted score out of the plurality of recognition target classes when the predicted score of the invalid class is less than the first threshold value.

According to the aspects of (1), (2), (13), and (14), it is possible to improve recognition accuracy of a target or an object including at least a sign in a traffic environment by classifying a recognition target as a recognition target class or an invalid class.

According to the aspect of (3), it is possible to further improve recognition accuracy of a target or an object including at least a sign in a traffic environment by classifying a recognition target class as an invalid class using the first classification processing unit.

According to the aspects of (4), (5), and (6), it is possible to further improve recognition accuracy of a target or an object including at least a sign in a traffic environment by classifying a recognition target class as a detailed recognition target class or an invalid class using the first classification processing unit.

According to the aspect of (7), it is possible to improve recognition accuracy of a target or an object including at least a sign by designing an appropriate loss function.

According to the aspect of (8), it is possible to improve recognition accuracy of a recognition target by changing a threshold value for classification as an invalid class according to the weather or geographical features or environmental conditions such as headlamps of neighboring vehicles or streetlamps.

According to the aspect of (9), it is possible to improve recognition accuracy of a recognition target by performing classification a plurality of times.

According to the aspect of (10), it is possible to secure recognition accuracy or to complement a recognition result through comparison between a traveling lane based on a map and a classified detailed arrow class.

According to the aspect of (11), it is possible to recognize a detailed character string class of a crossing and to perform notification or control of a vehicle.

According to the aspect of (12), it is possible to secure recognition accuracy or to complement a recognition result through comparison between a speed marking and a detailed speed class of a classified road marking.

### BRIEF DESCRIPTION OF THE DRAWINGS

FIG. 1 is a diagram illustrating a configuration of a vehicle system 1 using a vehicle control device according to an embodiment.

FIG. 2 is a block diagram illustrating an example of functional configurations of a first control unit 110 and a second control unit 120 according to the embodiment.

FIG. 3 is a block diagram illustrating an example of an internal configuration of a recognition unit 112 according to the embodiment.

FIG. 4 is a diagram illustrating a process of a road marking classifying unit 202 according to the embodiment.

FIG. 5 is a diagram illustrating a relationship between a first weight (λ1) and a second weight (λ2) and a certainty factor according to the embodiment.

FIG. 6 is a flowchart illustrating an example of a process flow that is performed by the recognition unit 112 according to the embodiment.

FIG. 7 is a diagram illustrating adjustment of a marking classification threshold value according to the embodiment.

### DETAILED DESCRIPTION OF THE INVENTION

Hereinafter, a recognition device, a recognition method, a vehicle control device, and a storage medium according to an embodiment of the present invention will be described with reference to the accompanying drawings.

### Entire Configuration

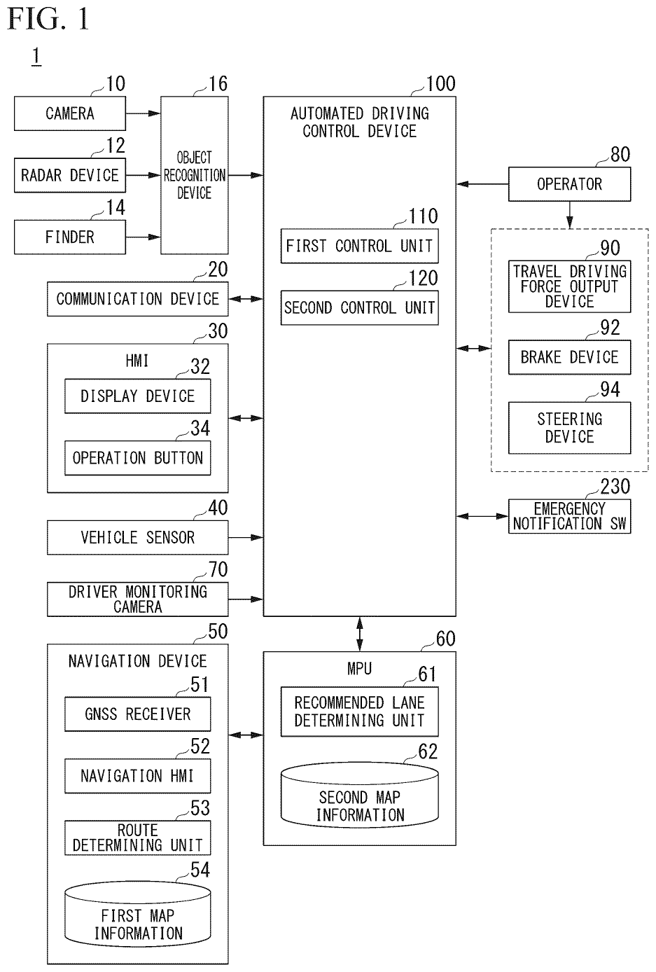

FIG. 1 is a diagram illustrating a configuration of a vehicle system 1 employing a vehicle control device according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driver monitoring camera 70, an operator 80, a travel driving force output device 90, a brake device 92, a steering device 94, and an automated driving control device 100. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto.

The camera 10 is an imaging unit that captures a surrounding image of a traveling lane in which the host vehicle M is traveling. The camera 10 is, for example, a digital camera using a solid-state imaging device such as a charge coupled device (CCD) or a complementary metal oxide semiconductor (CMOS). The camera 10 is attached to an arbitrary position on a vehicle (hereinafter referred to as a host vehicle M) in which the vehicle system 1 is mounted. The camera 10 is attached to an upper part of a front windshield, a rear surface of a rearview mirror, or the like. The camera 10 images the surroundings of the host vehicle M, for example, periodically and repeatedly. The camera 10 may be a stereo camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the host vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the host vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the automated driving control device 100. The object recognition device 16 may output the results of detection from the camera 10, the radar device 12, and the LIDAR device 14 to the automated driving control device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the host vehicle M and receives an input operation from the occupant. The HMI 30 includes, for example, a display device 32 and an operation button 34 and may include a speaker or a buzzer.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determining unit 53.

The navigation device 50 stores first map information 54 in a storage device such as a hard disk drive (HDD) or a flash memory.

The GNSS receiver 51 identifies a position of the host vehicle M on the basis of signals received from GNSS satellites. The position of the host vehicle M may be identified or complemented by an inertial navigation system (INS) using the output of the vehicle sensor 40.

The navigation HMI 52 includes a display device, a speaker, a touch panel, and keys. The navigation HMI 52 may be partially or wholly shared by the HMI 30.

For example, the route determining unit 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54.

The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determining unit 61 and stores second map information 62 in a storage device such as an HDD or a flash memory. The recommended lane determining unit 61 divides the route on a map provided from the navigation device 50 into a plurality of blocks (for example, blocks every 100 [m] in a vehicle traveling direction) and determines a recommended lane for each block with reference to the second map information 62. The recommended lane determining unit 61 determines in which lane from the leftmost the host vehicle M is to travel. When there is a branching point in the route on a map, the recommended lane determining unit 61 determines the recommended lane such that the host vehicle M can travel along a rational route for traveling to the branching destination.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, phone number information, and information of a prohibited section in which mode A or mode B which will be described later is prohibited. The second map information 62 may be updated from time to time by causing the communication device 20 to communicate with another device.

The driver monitoring camera 70 is, for example, a digital camera using a solid-state imaging device such as a CCD or a CMOS. The driver monitoring camera 70 is attached to an arbitrary position on the host vehicle M in a place and a direction in which the head of an occupant (hereinafter referred to as a driver) sitting on a driver's seat of the host vehicle M can be imaged from the front (such that the face of the driver is imaged). For example, the driver monitoring camera 70 is attached to an upper part of a display device which is provided at the center of an instrument panel of the host vehicle M.

The operator 80 includes, for example, a steering wheel, an accelerator pedal, a brake pedal, a shift lever, and other operators. A sensor that detects an amount of operation or whether an operation has been performed is attached to the operator 80, and results of detection of the sensor are output to the automated driving control device 100 or output to some or all of the travel driving force output device 90, the brake device 92, and the steering device 94. The operator 80 may not have to have a ring shape and may have a shape such as a deformed steering wheel, a joystick, or a button.

The automated driving control device 100 includes a first control unit 110 and a second control unit 120. The first control unit 110 and the second control unit 120 are realized, for example, by causing a hardware processor (a computer) such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the automated driving control device 100 in advance, or may be stored in a removable storage medium such as a DVD or a CD-ROM and installed in the HDD or the flash memory of the automated driving control device 100 by setting the removable storage medium (a non-transitory storage medium) into a drive device.

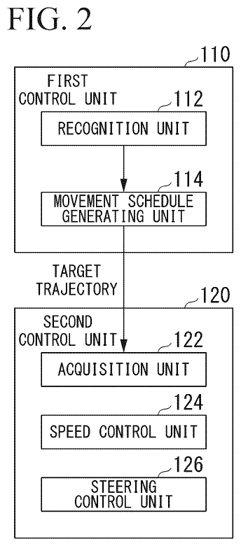

FIG. 2 is a block diagram illustrating an example of functional configurations of the first control unit 110 and the second control unit 120 according to the embodiment. The first control unit 110 includes, for example, a recognition unit 112 and a movement schedule generating unit 114. The first control unit 110 may be realized, for example, by both a function based on artificial intelligence (AI) and a function based on a predetermined model.

The recognition unit 112 recognizes a traffic marking which is a recognition target on the basis of information input via the camera 10. The recognition unit 112 may recognize a position of an object or the like near the host vehicle M. The recognition unit 112 may recognize a position of an object or the like on the basis of information input from the radar device 12 and the LIDAR device 14 via the object recognition device 16.

The recognition target is an object near the host vehicle M. An object near the host vehicle M is, for example, a traffic marking, and the traffic marking includes both a sign (a standing signboard) and a road marking drawn on a road surface. A position of an object is recognized, for example, as a position in an absolute coordinate system with a representative point (such as the center of gravity or a drive shaft center) of the host vehicle M as an origin and is used for control. A position of an object may be expressed as a representative point such as the center of gravity or a corner of the object or may be expressed as an area.

In the embodiment, detection and classification of a road marking out of traffic markings will be described, and processes associated with a road marking can also be applied to detection and classification of another marking (sign).

The recognition unit 112 may recognize, for example, a lane (a traveling lane) in which the host vehicle M is traveling on the basis of position information of the host vehicle (a traveling lane recognition unit). For example, the recognition unit 112 recognizes the traveling lane by comparing a pattern of road marking lines acquired from the second map information 62 (which may hereinafter be referred to as a “map road marking line) with a pattern of road marking lines near the host vehicle M recognized from an image captured by the camera 10 (which may hereinafter be referred to as a “camera road marking line”) in a monitoring range (a comparison range). The monitoring range may be a detection limit range of the recognition unit 112 or may be a part of the detection limit range. When another vehicle is traveling in the monitoring range in front of the host vehicle M, the recognition unit 112 may determine the camera road marking line to be compared with the map road marking line with reference to a trajectory of the other vehicle. For example, the recognition unit 112 may determine a marking line in a direction along the trajectory (speed) of the other vehicle out of a plurality of marking lines which are candidates for the camera road marking line as a camera road marking line.

The movement schedule generating unit 114 generates a target trajectory in which the host vehicle M will travel autonomously (without requiring a driver's operation) in the future such that the host vehicle M can travel in a recommended lane determined by the recommended lane determining unit 61 in principle and avoids approach of the host vehicle M to an object (other than an object which the host vehicle M can go over such as a road marking line, a road marking, or a manhole) recognized by the recognition unit 112. For example, the target trajectory is expressed by sequentially arranging points (trajectory points) at which the host vehicle M is to arrive. Trajectory points are points at which the host vehicle M is to arrive at intervals of a predetermined traveling distance (for example, about several [m]) along a road, and a target speed and a target acceleration at intervals of a predetermined sampling time (for example, below the decimal point [sec]) are generated as a part of the target trajectory in addition thereto.

The movement schedule generating unit 114 may set events of automated driving in generating a target trajectory. The events of automated driving include a constant-speed travel event, a low-speed following travel event, a lane change event, a branching event, a merging event, and an overtaking event. The movement schedule generating unit 114 generates a target trajectory based on an event which is started.

The second control unit 120 includes, for example, an acquisition unit 122, a speed control unit 124, and a steering control unit 126. The acquisition unit 122 acquires information of the target trajectory (trajectory points) generated by the movement schedule generating unit 114 and stores the acquired information in a memory (not illustrated). The speed control unit 124 controls the travel driving force output device 90 or the brake device 92 on the basis of speed elements accessory to the target trajectory stored in the memory. The steering control unit 126 controls the steering device 94 on the basis of a curved state of the target trajectory stored in the memory. The processes of the speed control unit 124 and the steering control unit 126 are realized, for example, by feed-forward control and feedback control in combination. For example, the steering control unit 126 performs control in combination of feed-forward control based on a curvature of a road on which the host vehicle M is traveling and feedback control based on separation from the target trajectory.

The travel driving force output device 90 outputs a travel driving force (a torque) for allowing the vehicle to travel to driving wheels. The travel driving force output device 90 includes, for example, a combination of an internal combustion engine, an electric motor, and a transmission and an electronic control unit (ECU) that controls them. The ECU controls these constituents on the basis of information input from the second control unit 120 or information input from the operator 80.

The brake device 92 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second control unit 120 or the information input from the operator 80 such that a brake torque based on a braking operation is output to vehicle wheels. The brake device 92 may include a mechanism for transmitting a hydraulic pressure generated by an operation of the brake pedal included in the operator 80 to the cylinder via a master cylinder as a backup. The brake device 92 is not limited to the above-mentioned configuration and may be an electronically controlled hydraulic brake device that controls an actuator on the basis of information input from the second control unit 120 such that the hydraulic pressure of the master cylinder is transmitted to the cylinder.

The steering device 94 includes, for example, a steering ECU and an electric motor. The electric motor changes a direction of turning wheels, for example, by applying a force to a rack-and-pinion mechanism. The steering ECU drives the electric motor on the basis of the information input from the second control unit 120 or the information input from the operator 80 to change the direction of the turning wheels.

For example, the automated driving control device 100 may recognize a road marking recognized by the recognition unit 112 before passing over the road marking and then control the host vehicle M using the recognition result (classification result) and other information. For example, when the host vehicle M is traveling at 80 km/h and a road marking 20 m in front is recognized, the road marking can be recognized using images corresponding to 5 frames in a period until the road marking will not be able to be imaged by the camera 10. The automated driving control device 100 recognizes a road marking required for stop such as STOP, KEEP, or CLEAR before reaching the road marking. When the host vehicle is traveling at 20 km/h and a road marking 20 m in front is recognized, the automated driving control device 100 stops the host vehicle M at a total of 10.1 m of a brake reaction distance (5.6 m) of 1 second and a stop distance (4.5 m).

### Entire Functional Configuration and Process of Recognition Unit 112

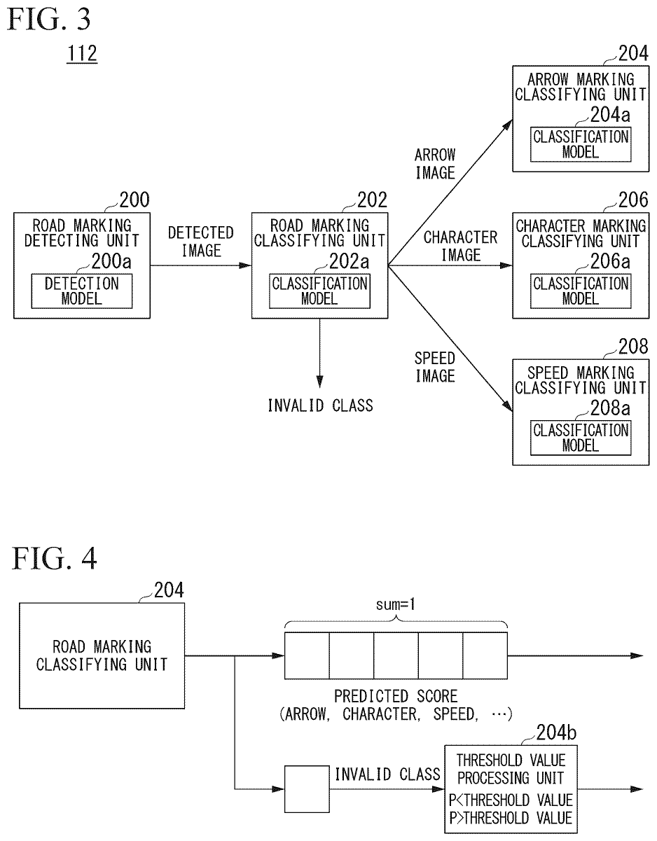

FIG. 3 is a block diagram illustrating an example of an internal configuration of the recognition unit 112 according to the embodiment. The recognition unit 112 includes, for example, a road marking detecting unit 200, a road marking classifying unit 202, an arrow marking classifying unit 204, a character marking classifying unit 206, and a speed marking classifying unit 208.

The road marking detecting unit 200 is a detection unit that detects a traffic marking area (which corresponds to a recognition target area or a road marking area) including a traffic marking from an image captured by the camera 10. The road marking detecting unit 200 receives an input of an image captured by the camera 10 and outputs an image including a traffic marking area including a traffic marking. The road marking detecting unit 200 may output an image including a traffic marking area, for example, using a detection model 200a employing a YOLO (You Only Look Once) algorithm.

The road marking classifying unit 202, the arrow marking classifying unit 204, the character marking classifying unit 206, and the speed marking classifying unit 208 are classification units that calculate a predicted score of each of a plurality of traffic marking classes (which correspond to recognition target classes or road marking classes) and an invalid class using the image of the traffic marking area detected by the road marking detecting unit 200 and classify the traffic marking as one of the plurality of traffic marking classes and the invalid class on the basis of the calculated predicted scores. The processing results from the classification units are recognition results obtained by recognizing the traffic marking using the recognition unit 112.

The road marking classifying unit 202 is a first classification processing unit that classifies the traffic marking as the invalid class when the predicted score of the invalid class is greater than a predetermined first threshold value (a marking classification threshold value, an RMNet threshold value) and classifies the traffic marking as a first traffic marking class (which corresponds to a first recognition target class) with the highest predicted score out of the plurality of traffic marking classes when the predicted score of the invalid class is less than the marking classification threshold value. The predicted score of a traffic marking class has a higher value as the likelihood that an image of the traffic marking area represents the traffic marking becomes higher. The predicted score of the invalid class has a higher value as the likelihood that an image of the traffic marking area does not represent the traffic marking becomes higher.

The road marking classifying unit 202 receives an input of an image of a traffic marking area output from the road marking detecting unit 200 and outputs an image of the traffic marking area to which a traffic marking label or an invalid label is added.

The road marking classifying unit 202 may add a label to an image of a traffic marking area, for example, using a classification model 202a employing a regional memory network (RMNet) algorithm or the like.

The road marking classifying unit 202 adds an arrow label, a character string label, a speed label, or an invalid label as a traffic marking label to the image of the traffic marking area. The arrow label is information indicating an image including an arrow of moving ahead, right turn, left turn, U turn, or the like as a traffic marking. The character string label is information indicating an image including a character string such as alphabetical letters such as STOP as a traffic marking. The speed label is information indicating an image including a speed limit such as 50 or 100 as a traffic marking. The invalid label is information indicating an image including none of an arrow, a character string, and a speed. The road marking classifying unit 202 in the embodiment adds the arrow label, the character string label, or the speed label as a label, but the present invention is not limited thereto, and the traffic marking may be re-classified as another traffic marking such as a bicycle mark or a railroad crossing.

The road marking classifying unit 202 classifies an image of a traffic marking area as the arrow class by outputting an image of the traffic marking area with the arrow label to the arrow marking classifying unit 204. The road marking classifying unit 202 classifies an image of a traffic marking area as the character string class by outputting an image of the traffic marking area with the character string label to the character marking classifying unit 206. The road marking classifying unit 202 classifies an image of a traffic marking area as the speed class by outputting an image of the traffic marking area with the speed label to the speed marking classifying unit 208.

The arrow marking classifying unit 204, the character marking classifying unit 206, and the speed marking classifying unit 208 serve as a second classification processing unit that calculates a predicted score of a first invalid class using a traffic marking in a first traffic marking class classified by the road marking classifying unit 202 (the first classification processing unit) and classifies the traffic marking as the invalid class when the predicted score of the first invalid class is greater than a detailed classification threshold value (a second threshold value). The detailed classification threshold value is a threshold value which is set for each type of traffic marking and is a threshold value which is set to distinguish the detailed traffic marking classes from the invalid class.

The arrow marking classifying unit 204 receives an input of an image of a traffic marking area with the arrow label from the road marking classifying unit 202 and classifies the image into detailed arrows. The arrow marking classifying unit 204 calculates a predicted score of the invalid class using the traffic marking classified as the arrow class by the road marking classifying unit 202 and classifies the traffic marking as the invalid class when the predicted score of the invalid class is greater than a detailed arrow classification threshold value (a third threshold value).

The detailed arrow classification threshold value is a threshold value which is set to distinguish the detailed arrow classes from the invalid class.

When the predicted score of the invalid class is less than the detailed arrow classification threshold value, the arrow marking classifying unit 204 calculates a predicted score of each of a plurality of detailed arrow classes and classifies the traffic marking as the detailed arrow class with the highest predicted score out of the plurality of detailed arrow classes. Each of the plurality of detailed arrow classes is different from another detailed arrow class in shape and direction of an arrow.

The character marking classifying unit 206 receives an input of an image of a traffic marking area with the character string label from the road marking classifying unit 202 and classifies the image into detailed character strings. The character marking classifying unit 206 calculates a predicted score of the invalid class using the traffic marking classified as the character string class by the road marking classifying unit 202 and classifies the traffic marking as the invalid class when the predicted score of the invalid class is greater than a detailed character string classification threshold value (a fourth threshold value).

The detailed character string classification threshold value is a threshold value which is set to distinguish the detailed character string classes from the invalid class.

When the predicted score of the invalid class is less than the detailed character string classification threshold value, the character marking classifying unit 206 calculates a predicted score of each of a plurality of detailed character string classes and classifies the traffic marking as the detailed character string class with the highest predicted score out of the plurality of detailed character string classes. Each of the plurality of detailed character string classes is different from another detailed character string class in content and meaning of a character string.

The speed marking classifying unit 208 receives an input of an image of a traffic marking area with the speed label from the road marking classifying unit 202 and classifies the image into detailed speeds. The speed marking classifying unit 208 calculates a predicted score of the invalid class using the traffic marking classified as the speed class by the road marking classifying unit 202 and classifies the traffic marking as the invalid class when the predicted score of the invalid class is greater than a detailed speed classification threshold value (a fifth threshold value).

The detailed speed classification threshold value is a threshold value which is set to distinguish the detailed speed classes from the invalid class.

When the predicted score of the invalid class is less than the detailed speed classification threshold value, the speed marking classifying unit 208 calculates a predicted score of each of a plurality of detailed speed classes and classifies the traffic marking as the detailed speed class with the highest predicted score out of the plurality of detailed speed classes. Each of the plurality of detailed speed class is different from another detailed speed class in numerical value of a speed.

### Detailed Processes of Road Marking Classifying Unit 202

FIG. 4 is a diagram illustrating processes of the road marking classifying unit 202 according to the embodiment. The road marking classifying unit 202 may calculate, for example, a total of 6 predicted scores of 5 traffic marking classes including an arrow class, a character class, a speed class, a bicycle mark class, and a railroad crossing notice class and one invalid class. The road marking classifying unit 202 calculates 5 predicted scores such that the sum of the predicted scores of 5 traffic marking classes is “1.” The road marking classifying unit 202 calculates the predicted scores such that the predicted score of the invalid class ranges from 0 to 1. A loss function in this model is as follows.

Loss=λ1×CE(5 classes)+λ2×BCE(invalid classes)

CE in the loss function is cross entropy (a first loss value), and BCE is binomial entropy (a second loss value).

The road marking classifying unit 202 calculates a cross entropy for the predicted scores of the traffic marking classes (valid classes) and a binomial entropy for the predicted score of the invalid class and performs classification using a machine learning model having learned a value obtained by adding a value obtained by multiplying the cross entropy by a first weight (λ1) and a value obtained by multiplying the binomial entropy by a second weight (λ2) as a loss function. Here, a binomial entropy has been described, but another function may be used, for example, a mean square error may be used. Separate loss functions such as a cross entropy and a binomial entropy are used, but they may be the same loss function.

The road marking classifying unit 202 includes a threshold value processing unit 204b that classifies a traffic marking as the invalid class when the predicted score P of the invalid class is greater than the marking classification threshold value (the first threshold value). When the predicted score of binary classification of the invalid class is equal to or greater than the marking classification threshold value, the road marking classifying unit 202 classifies the traffic marking as the invalid class. Classification as the invalid class may mean that an invalid label or another label is added to an image of the traffic marking. Accordingly, the road marking classifying unit 202 can detect an image of the invalid class out of the detected road marking images and enhance recognition accuracy of road markings by designing an appropriate loss function.

### Adjustment of λ1 and λ2

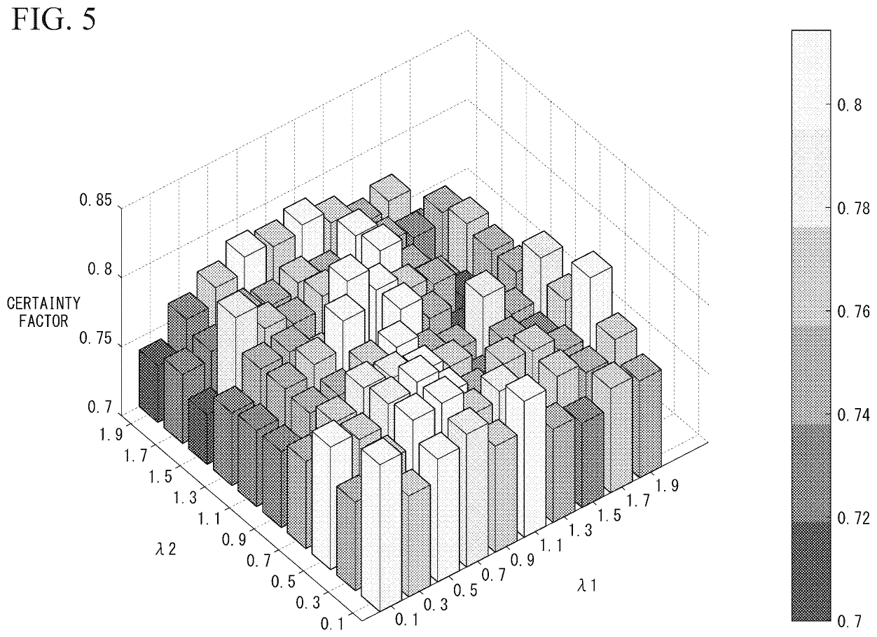

FIG. 5 is a diagram illustrating a relationship between the first weight (λ1) and the second weight (λ2) and a certainty factor according to the embodiment.

In order to perform optimization of loss coefficients in the road marking classifying unit 202, it is necessary to appropriately set the first weight (λ1) and the second weight (λ2). The prediction accuracy of a classification model 202a having learned a loss function in which ten λ1 and ten λ2 are selected between 0.1 to 0.9 and 10×10 is set has been derived. As a result, it has been seen that the prediction accuracy is the highest in the range of λ1 of 0.5 to 0.7 and in the range of λ2 of 0.3 to 0.7. By setting λ1 to the range of 0.5 to 0.7 and setting λ2 to the range of λ2 of 0.3 to 0.7 in the loss coefficients, the road marking classifying unit 202 can classify the traffic marking classes and the invalid classes with high prediction accuracy.

The trend of the prediction accuracy for λ1 and λ2 may vary according to training data, algorithms, or parameters of the machine learning model (the classification model 202a). On the other hand, it is possible to perform optimization of the loss coefficients by adjusting λ1 and λ2 such that the prediction accuracy of each machine learning model is improved. Here, the road marking classifying unit 202 calculates 5 predicted scores such that the sum of the predicted scores of 5 traffic marking classes is “1,” but the predicted scores may not be calculated such that the sum of the predicted scores is “1,” or the predicted scores may be calculated numerals.

### Process Flow of Recognition Unit 112

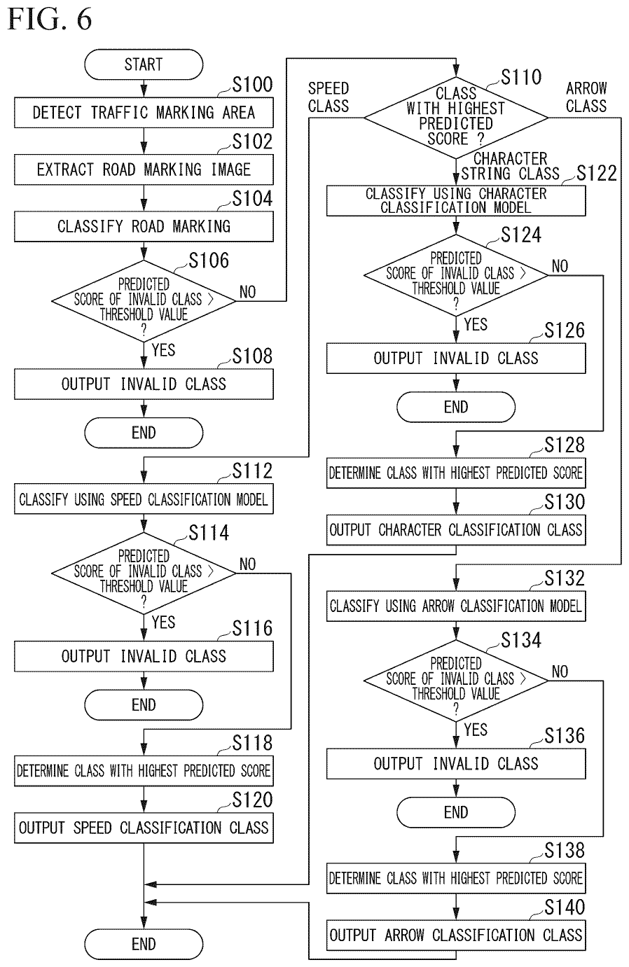

FIG. 6 is a flowchart illustrating an example of a process flow that is performed by the recognition unit 112 according to the embodiment. The recognition unit 112 repeats the process flow in the flowchart when an image captured by the camera 10 is acquired while the host vehicle M is traveling.

First, the recognition unit 112 acquires an image, and the road marking detecting unit 200 detects a traffic marking area from the acquired image (Step S100) and extracts a road marking image (Step S102).

Then, the road marking classifying unit 202 calculates a predicted score of an arrow class, a predicted score of a character class, a predicted score of a speed class, a predicted score of a speed class, and a predicted score of an invalid class using the road marking image detected by the road marking detecting unit 200 and classifies a road marking as the arrow class, the character class, or the speed class (Step S104).

Then, the road marking classifying unit 202 determines whether the predicted score of the invalid class is greater than the first threshold value (Step S106). When the predicted score of the invalid class is greater than the marking classification threshold value, the road marking classifying unit 202 classifies the road marking as the invalid class (Step S106: YES) and outputs the invalid class to the movement schedule generating unit 114 from the recognition unit 112 (Step S108).

When the predicted value of the invalid class is not greater than the marking classification threshold value (Step S106: NO), the road marking classifying unit 202 determines a traffic marking class with the highest predicted score (Step S110). When the traffic marking class with the highest predicted score is the speed class, the road marking classifying unit 202 classifies the road marking as the speed class (Step S112). The speed marking classifying unit 208 calculates the predicted score of the detailed speed classes and the predicted score of the invalid class using the image with a speed label supplied from the road marking classifying unit 202 and determines whether the predicted score of the invalid class is greater than the detailed speed classification threshold value (Step S114).

When the predicted score of the invalid class is greater than the detailed speed classification threshold value (Step S114: YES), the speed marking classifying unit 208 classifies the road marking as the invalid class and outputs the invalid class to the movement schedule generating unit 114 from the recognition unit 112 (Step S116).

When the predicted score of the invalid class is less than the detailed speed classification threshold value (Step S114: NO), the speed marking classifying unit 208 determines the detailed speed class with the highest predicted score (Step S118) and outputs the determined detailed speed class to the movement schedule generating unit 114 (Step S120).

When the road marking classifying unit 202 determines the traffic marking class with the highest predicted score (Step S110) and the traffic marking class with the highest predicted score is the character string class, the road marking classifying unit 202 classifies the traffic marking as the character string class (Step S122). The character marking classifying unit 206 calculates the predicted score of the detailed character string classes and the predicted score of the invalid class using the image with a character string label supplied from the road marking classifying unit 202 and determines whether the predicted score of the invalid class is greater than the detailed character string classification threshold value (Step S124).

When the predicted score of the invalid class is greater than the detailed character string classification threshold value (Step S124: YES), the character marking classifying unit 206 classifies the road marking as the invalid class and outputs the invalid class to the movement schedule generating unit 114 from the recognition unit 112 (Step S126).

When the predicted score of the invalid class is less than the detailed character string classification threshold value (Step S124: NO), the character marking classifying unit 206 determines the detailed character string class with the highest predicted score (Step S128) and outputs the determined detailed character string class to the movement schedule generating unit 114 (Step S130).

When the road marking classifying unit 202 determines the traffic marking class with the highest predicted score (Step S110) and the traffic marking class with the highest predicted score is the arrow class, the road marking classifying unit 202 classifies the traffic marking as the arrow class (Step S132). The arrow marking classifying unit 204 calculates the predicted score of the detailed arrow classes and the predicted score of the invalid class using the image with an arrow label supplied from the road marking classifying unit 202 and determines whether the predicted score of the invalid class is greater than the detailed arrow classification threshold value (Step S134). When the predicted score of the invalid class is greater than the detailed arrow classification threshold value (Step S134: YES), the arrow marking classifying unit 204 classifies the road marking as the invalid class and outputs the invalid class to the movement schedule generating unit 114 from the recognition unit 112 (Step S136).

When the predicted score of the invalid class is less than the detailed arrow classification threshold value (Step S134: NO), the arrow marking classifying unit 204 determines the detailed arrow class with the highest predicted score (Step S138) and outputs the determined detailed arrow class to the movement schedule generating unit 114 (Step S140).

In this flowchart, the recognition unit 112 classifies a road marking, for example, at intervals of a predetermined period in which an image is captured. The recognition unit 112 may output the classification result on the basis of a result of comparison between the classification result in the previous period and the classification result in the current period. For example, the recognition unit 112 consecutively outputs the detailed arrow class, but when the classification result in the current period is the detailed speed class, the recognition unit 112 may not output the classification result in the detailed speed class to the movement schedule generating unit 114. Thereafter, when the consecutive classification results are the detailed speed class, the recognition unit 112 may output the classification result of the detailed speed class to the movement schedule generating unit 114. In this way, the recognition unit 112 can improve the recognition accuracy of a road marking by comparing the classification result in the previous period and the classification result in the current period and repeatedly performing the classification a plurality of times.

Outputting of the classification result based on the result of comparison between the classification result in the previous period and the classification result in the current period may be performed on the traffic marking class and the invalid class output from the road marking classifying unit 202.

### Adjustment of First Threshold Value (Marking Classification Threshold Value, RMNet Threshold Value)

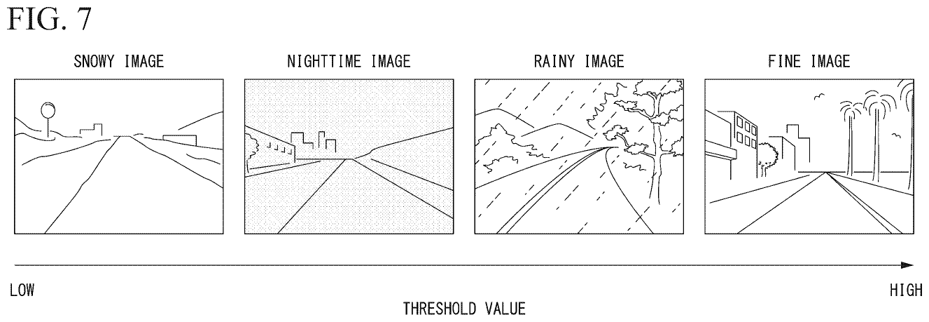

FIG. 7 is a diagram illustrating adjustment of the marking classification threshold value according to the embodiment.

The recognition unit 112 preferably changes the marking classification threshold value to a smaller value as the likelihood that the classification accuracy will be lowered due to environmental conditions such as the weather or geographical features near the host vehicle M, headlamps of nearby vehicles, or streetlamps becomes higher. The recognition unit 112 preferably changes the marking classification threshold value or the detailed classification threshold value to a smaller value as the likelihood that the classification accuracy will be lowered due to environmental conditions near the host vehicle M becomes higher. For example, the likelihood of recognition of a traffic marking in the surrounding image varies according to whether the weather is snowy, whether it is the nighttime, whether the weather is rainy, or whether the weather is fine. Unevenness on a road surface makes it more difficult to recognize a road marking.

Therefore, when the surrounding image is clear such as when it is fine or when it is cloudy, erroneous detection (over-detection) of a traffic marking in the road marking detecting unit 200 is curbed, and thus the recognition unit 112 can set the marking classification threshold value or the detailed classification threshold value to be higher.

On the other hand, when the weather is snowy, it is the nighttime, or the weather is rainy, the surrounding image includes much noise, over-detection of detecting an area not including a traffic marking increases, and the classification accuracy may decrease.

Accordingly, the recognition unit 112 sets the marking classification threshold value or the detailed classification threshold value to be smaller as the likelihood that the classification accuracy will decrease becomes higher. By setting the marking classification threshold value or the detailed classification threshold value to be smaller, the probability of classification as the invalid class can be decreased, and the probability of classification as the traffic marking class can be increased. Accordingly, the recognition unit 112 can improve the recognition accuracy of a traffic marking.

### Vehicle Control Based on Detailed Arrow Class

The movement schedule generating unit 114, the speed control unit 124, and the steering control unit 126 serve as a vehicle control unit that controls the host vehicle M on the basis of a traffic marking recognized by the recognition unit 112 (the recognition device). The automated driving control device 100 includes the recognition unit 112 as a traveling lane recognizing unit that recognizes the traveling lane of the host vehicle M on the basis of the second map information 62. The vehicle control unit may compare a shape and a direction of the detailed arrow class recognized by the recognition unit 112 (the recognition device) with the traveling lane recognized by the recognition unit 112 (the traveling lane recognizing unit) and verify the recognition accuracy of the recognition device on the basis of the result of comparison.

For example, the movement schedule generating unit 114 determines that the recognition result of the detailed arrow class is correct when the shape and the direction of the detailed arrow class match the traveling lane recognized from the second map information 62. Specifically, when the direction indicated by the detailed arrow class is left turn and the traveling lane recognized from the second map information 62 is a left-turn lane, it is determined that the recognition result of the detailed arrow class is correct. When the direction indicated by the detailed arrow class is left turn and the traveling lane recognized from the second map information 62 is a straight lane, it is determined that the recognition result of the detailed arrow class is incorrect.

With the automated driving control device 100, it is possible to secure the recognition accuracy by comparing the shape and the direction of the detailed arrow class with the traveling lane recognized from the second map information 62. With the automated driving control device 100, it is possible to correct the recognized detailed arrow class using the traveling lane recognized from the second map information 62. As a result, with the automated driving control device 100, it is possible to recognize a traffic marking with higher accuracy.

### Vehicle Control Based on Detailed Character String Class

When characters of the detailed character string class recognized by the recognition unit 112 (the recognition device) are characters associated with a crossing, the automated driving control device 100 may notify an occupant of the host vehicle M or control the speed of the host vehicle M. For example, when the detailed character string class indicates a crossing, the automated driving control device 100 can notify that the host vehicle M approaches the crossing using the HMI 30 and curb the increase of the speed of the host vehicle M as it becomes closer to the crossing.

For example, character strings “STOP,” “AHEAD,” “XING AHEAD,” “SIGNAL AHEAD,” and “PED AHEAD” represent notifies of temporary stop, a crossing, a traffic signal, and a crosswalk. When the recognition unit 112 recognizes such traffic markings, the automated driving control device 100 can control the host vehicle M such that the host vehicle M decelerates in preparation of stop.

When the character marking classifying unit 206 recognizes a detailed character string class of “R” and the classification class in the road marking classifying unit 202 includes a “railroad crossing notice class,” it is possible to enhance the certainty factor of the railroad crossing notice class in the road marking classifying unit 202 by matching the classification result of the character marking classifying unit 206 with the classification result of the road marking classifying unit 202. The automated driving control device 100 can correct the classification result of the character marking classifying unit 206 using the classification result of the road marking classifying unit 202 and control the host vehicle M on the basis of the classification result of the character marking classifying unit 206.

### Vehicle Control Based on Detailed Speed Class

The recognition unit 112 may compare the speed of the detailed speed class recognized by the road marking detecting unit 200, the road marking classifying unit 202, and the speed marking classifying unit 208 with the speed when a speed marking of a signboard is recognized from an image through pattern matching by a speed marking recognizing unit and may notify the occupant of the host vehicle M or control the speed of the host vehicle M on the basis of the result of comparison. The speed marking recognizing unit is a function of recognizing a speed marking of a signboard from an image by performing processing in cooperation with the road marking detecting unit 200, the road marking classifying unit 202, and the speed marking classifying unit 208. The speed when the speed marking of a signboard is recognized and the speed of the detailed speed class are compared, but the present invention is not limited thereto, and the recognized detailed speed class may be notified of without any change or the speed of the host vehicle M may be controlled on the basis of the recognized detailed speed class.

For example, the movement schedule generating unit 114 determines that the recognition result of the detailed speed class is correct when the speed limit of the speed marking of the signboard matches the speed limit of the detailed speed class and determines that the recognition result of the detailed speed class is incorrect when they do not match. With the automated driving control device 100, it is possible to secure the recognition accuracy by comparing the speed limit of the speed marking of a signboard with the speed limit of the detailed speed class. With the automated driving control device 100, it is possible to correct the recognized detailed speed class using the speed marking of the signboard. As a result, with the automated driving control device 100, it is possible to recognize a traffic marking with higher accuracy.

As described above, with the automated driving control device 100 according to the embodiment, the road marking classifying unit 202 can perform rough classification of classifying an image for each element of a traffic marking and classify a target (such as a manhole and scribbles) not included in training data and over-detected by the road marking detecting unit 200 as the invalid class. The arrow marking classifying unit 204, the character marking classifying unit 206, and the speed marking classifying unit 208 may be able to perform detailed classification of a road arrow, a road character string, or a road speed limit which is information required for control (driving assistance) of the host vehicle M and perform classification as the invalid class. Accordingly, with the automated driving control device 100, even when the road marking detecting unit 200 is allowed to over-detect a traffic marking and fully detects a traffic marking, it is possible to curb erroneous recognition due to over-detection by classifying the detected traffic marking as the invalid class using the road marking classifying unit 202, the arrow marking classifying unit 204, the character marking classifying unit 206, and the speed marking classifying unit 208. As a result, with the automated driving control device 100, it is possible to improve the recognition accuracy of a marking in a traffic environment.

While exemplary embodiments of the present invention have been described above, the present invention is not limited to the embodiments and can have various modifications and substitutions applied thereto without departing from the gist of the present invention.

What is claimed is:

1. A recognition device comprising:
an imaging unit configured to capture a surroundings image of a traveling lane in which a host vehicle is traveling;
a detection unit configured to detect a recognition target area including a recognition target from the surrounding image captured by the imaging unit; and
a classification unit configured to calculate a predicted score of each of a plurality of recognition target classes and an invalid class using an image of the recognition target area detected by the detection unit and to classify the recognition target as one of the plurality of recognition target classes and the invalid class on the basis of the calculated predicted scores,
wherein the classification unit includes a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value.

2. The recognition device according to claim 1, wherein the recognition target is a road marking,
wherein the detection unit detects a road marking area from the surrounding image, and
wherein the classification unit calculates the predicted score of each of a plurality of road marking classes and an invalid class using an image of the road marking area detected by the detection unit and classifies the road marking as one of the plurality of road marking classes and the invalid class on the basis of the calculated predicted scores.

3. The recognition device according to claim 1, wherein the classification unit includes a second classification processing unit configured to calculate a predicted score of a first invalid class using the recognition target in the first recognition target class classified by the first classification processing unit and to classify the recognition target as the invalid class when the predicted score of the first invalid class is greater than a second threshold value.

4. The recognition device according to claim 1, wherein the classification unit includes a second classification processing unit configured to:
calculate the predicted score of the invalid class using the recognition target classified as an arrow class which is the first recognition target class by the first classification processing unit;
classify the recognition target as the invalid class when the predicted score of the invalid class is greater than a third threshold value;
calculate a predicted score of each of a plurality of detailed arrow classes including a shape and a direction of an arrow when the predicted score of the invalid class is less than the third threshold value; and
classify the recognition target as the detailed arrow class with the highest predicted score out of the plurality of detailed arrow classes.

5. The recognition device according to claim 1, wherein the classification unit includes a second classification processing unit configured to:
calculate the predicted score of the invalid class using the recognition target classified as a character string class which is the first recognition target class by the first classification processing unit;
classify the recognition target as the invalid class when the predicted score of the invalid class is greater than a fourth threshold value;
calculate a predicted score of each of a plurality of detailed character string classes including a meaning of a character string when the predicted score of the invalid class is less than the fourth threshold value; and
classify the recognition target as the detailed character string class with the highest predicted score out of the plurality of detailed character string classes.

6. The recognition device according to claim 1, wherein the classification unit includes a second classification processing unit configured to:
calculate the predicted score of the invalid class using the recognition target classified as a speed class which is the first recognition target class by the first classification processing unit;
classify the recognition target as the invalid class when the predicted score of the invalid class is greater than a fifth threshold value;
calculate a predicted score of each of a plurality of detailed speed classes including a numerical value of a speed when the predicted score of the invalid class is less than the fifth threshold value; and
classify the recognition target as the detailed speed class with the highest predicted score out of the plurality of detailed speed classes.

7. The recognition device according to claim 1, wherein the first classification processing unit calculates a first loss value for the predicted score of the first recognition target class and a second loss value for the predicted score of the invalid class, and
wherein the first classification processing unit performs classification using a machine learning model learning a value obtained by adding a value obtained by multiplying the first loss value by a first weight and a value obtained by multiplying the second loss value by a second weight as a loss function.

8. The recognition device according to claim 1, wherein the first threshold value is changed to a smaller value as a classification accuracy becomes lower due to surrounding environmental conditions of the host vehicle.

9. The recognition device according to claim 1, wherein the classification unit performs classification of the recognition target at intervals of a predetermined period and outputs a classification result on the basis of a result of comparison between a classification result of a previous period and a classification result of a current period.

10. A vehicle control device comprising:
a recognition device including
an imaging unit configured to capture a surrounding image of a traveling lane in which a host vehicle is traveling,
a detection unit configured to detect a recognition target area including a recognition target from the surrounding image captured by the imaging unit, and
a classification unit configured to calculate a predicted score of each of a plurality of recognition target classes and an invalid class using an image of the recognition target area detected by the detection unit and to classify the recognition target as one of the plurality of recognition target classes and the invalid class on the basis of the calculated predicted scores,
wherein the classification unit includes
a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value, and
a second classification processing unit configured to calculate the predicted score of the invalid class using the recognition target classified as an arrow class which is the first recognition target class by the first classification processing unit, to classify the recognition target as the invalid class when the predicted score of the invalid class is greater than a third threshold value, to calculate a predicted score of each of a plurality of detailed arrow classes including a shape and a direction of an arrow when the predicted score of the invalid class is less than the third threshold value, and to classify the recognition target as the detailed arrow class with the highest predicted score out of the plurality of detailed arrow classes;
a vehicle control unit configured to control a vehicle on the basis of the recognition target recognized by the recognition device; and
a traveling lane recognizing unit configured to recognize the traveling lane of the host vehicle on the basis of position information of the host vehicle,
wherein the vehicle control unit compares the shape and the direction of the detailed arrow class recognized by the recognition device with the traveling lane recognized by the traveling lane recognizing unit and verifies a recognition accuracy of the recognition device on the basis of a result of comparison.

11. A vehicle control device comprising:
a recognition device including
an imaging unit configured to capture a surrounding image of a traveling lane in which a host vehicle is traveling,
a detection unit configured to detect a recognition target area including a recognition target from the surrounding image captured by the imaging unit, and
a classification unit configured to calculate a predicted score of each of a plurality of recognition target classes and an invalid class using an image of the recognition target area detected by the detection unit and to classify the recognition target as one of the plurality of recognition target classes and the invalid class on the basis of the calculated predicted scores,
wherein the classification unit includes
a first classification processing unit configured to classify the recognition target as the invalid class when the predicted score of the invalid class is greater than a predetermined first threshold value and to classify the recognition target as a first recognition target class with the highest predicted score out of the plurality of recognition target classes when the predicted score of the invalid class is less than the first threshold value, and
a second classification processing unit configured to calculate the predicted score of the invalid class using the recognition target classified as a character string class which is the first recognition target class by the first classification processing unit, to classify the recognition target as the invalid class when the predicted score of the invalid class is greater than a fourth threshold value, to calculate a predicted score of each of a plurality of detailed character string classes including a meaning of a character string when the predicted score of the invalid class is less than the fourth threshold value, and to classify the recognition target as the detailed character string class with the highest predicted score out of the plurality of detailed character string classes; and
a vehicle control unit configured to control a vehicle on the basis of the recognition target recognized by the recognition device,
wherein the vehicle control unit notifies an occupant of the host vehicle or controls a speed of the host vehicle when characters of the detailed character string class recognized by the recognition device are characters associated with a crossing.

12. A vehicle control device comprising:
a recognition device including
an imaging unit configured to capture a surrounding image of a traveling lane in which a host vehicle is traveling,
a detection unit configured to detect a road marking area including a road marking from the surrounding image captured by the imaging unit,
a classification unit configured to calculate a predicted score of each of a plurality of road marking class and an invalid class using an image of the road marking area detected by the detection unit and to classify the road marking as one of the plurality of road marking classes and the invalid class on the basis of the calculated predicted scores,
wherein the classification unit includes
a first classification processing unit configured to classify the road marking as the invalid class when the predicted score of the invalid class is greater than a predetermined first threshold value and to classify the road marking as a first road marking class with the highest predicted score out of the plurality of road marking classes when the predicted score of the invalid class is less than the first threshold value, and
a second classification processing unit configured to calculate the predicted score of the invalid class using the road marking classified as a speed class which is the first road marking class by the first classification processing unit, to classify the road marking as the invalid class when the predicted score of the invalid class is greater than a fifth threshold value, to calculate a predicted score of each of a plurality of detailed speed classes including a numerical value of a speed when the predicted score of the invalid class is less than the fifth threshold value, and to classify the road marking as the detailed speed class with the highest predicted score out of the plurality of detailed speed classes, and
a speed marking recognizing unit configured to recognize a speed marking from the surrounding image captured by the imaging unit; and
a vehicle control unit configured to control a vehicle on the basis of the road marking recognized by the recognition device,
wherein the vehicle control unit compares a speed of the detailed speed class recognized by the recognition device with a speed of the speed marking recognized by the speed marking recognizing unit and notifies an occupant of the host vehicle or controls a speed of the host vehicle on the basis of a result of comparison.

13. A recognition method that is performed by a computer, the recognition method comprising:
detecting a recognition target area including a recognition target from a surrounding image captured by an imaging unit configured to capture a surrounding image of a traveling lane in which a host vehicle is traveling;
calculating a predicted score of each of a plurality of recognition target classes and an invalid class using an image of the detected recognition target area;
classifying the recognition target as one of the plurality of recognition target classes and the invalid class on the basis of the calculated predicted scores;
classifying the recognition target as the invalid class when the predicted score of the invalid class is greater than a predetermined first threshold value; and
classifying the recognition target as a first recognition target class with the highest predicted score out of the plurality of recognition target classes when the predicted score of the invalid class is less than the first threshold value.

14. A non-transitory computer-readable storage medium storing a program, the program causing a computer to perform:
detecting a recognition target area including a recognition target from a surrounding image captured by an imaging unit configured to capture a surrounding image of a traveling lane in which a host vehicle is traveling;
calculating a predicted score of each of a plurality of recognition target classes and an invalid class using an image of the detected recognition target area;
classifying the recognition target as one of the plurality of recognition target classes and the invalid class on the basis of the calculated predicted scores;
classifying the recognition target as the invalid class when the predicted score of the invalid class is greater than a predetermined first threshold value; and
classifying the recognition target as a first recognition target class with the highest predicted score out of the plurality of recognition target classes when the predicted score of the invalid class is less than the first threshold value.
